(19) United States
(12) Patent Application Publication
(10) Pub. No.: US 2005/0252481 A1
(43) Pub. Date: Nov. 17, 2005

(54) Critical engine component protection covers

(76) Inventor: Michael L. Garner, Gray, TN (US)

Correspondence Address: Michael L. Garner, 122 Hillrise Road, Gray, TN, 37615, US

(21) Appl. No.: 11/125,694

(22) Filed: May 10, 2005

Related U.S. Application Data
(60) Provisional application No. 60/571,787, filed on May 17, 2004.

(51) Int. Cl. F02F 1/36

(52) U.S. Cl. 123/198 E

(57) ABSTRACT

A component cover for internal combustion engines, being a support tool for professional and non-professional automotive mechanics, for covering and protecting critical engine component openings that are revealed upon engine component removal for repairs, rebuild, and/or storage, which will custom fit engine component openings similiar to an original equipment component gasket and will attach to said openings by specially designed tabs either molded on covers or can attach through covers thereby providing a method to hold covers in place securely to cover and protect said critical engine component openings from inadvertant or accidental entry of foreign objects/debris and also protecting machined surfaces from inadvertant or accidental damage while maintenance is performed on said engines.

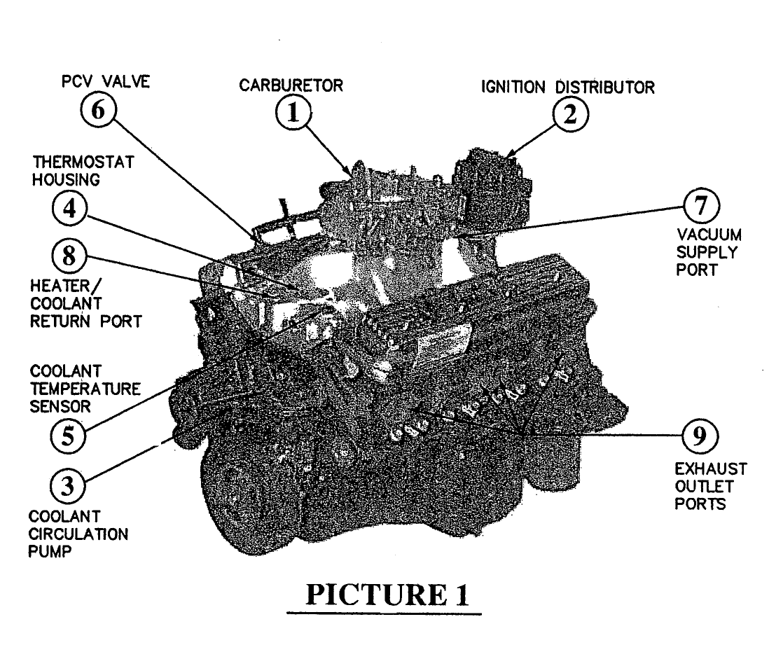

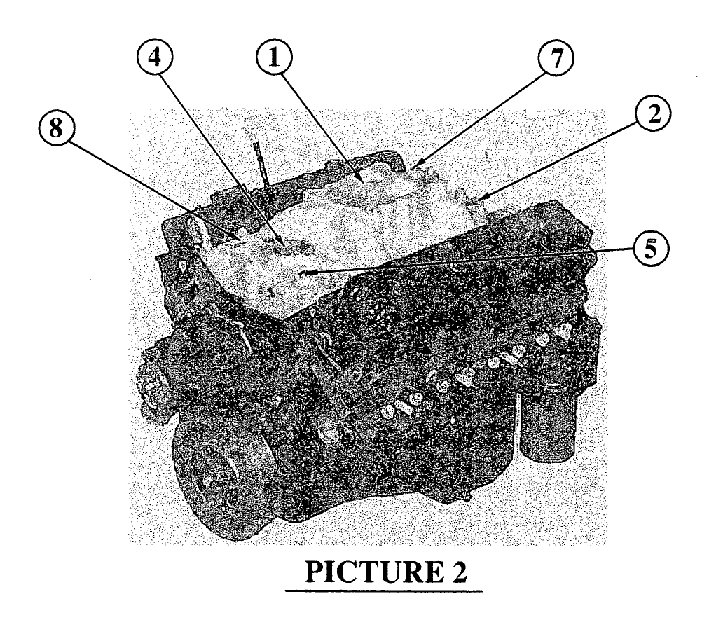

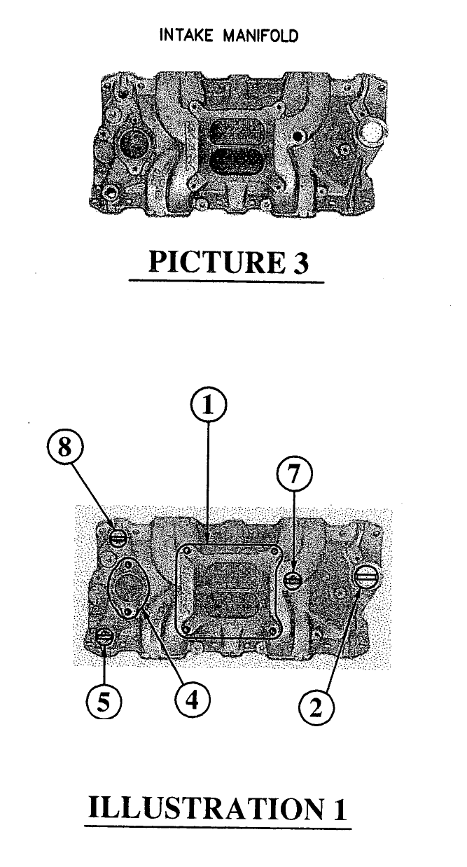

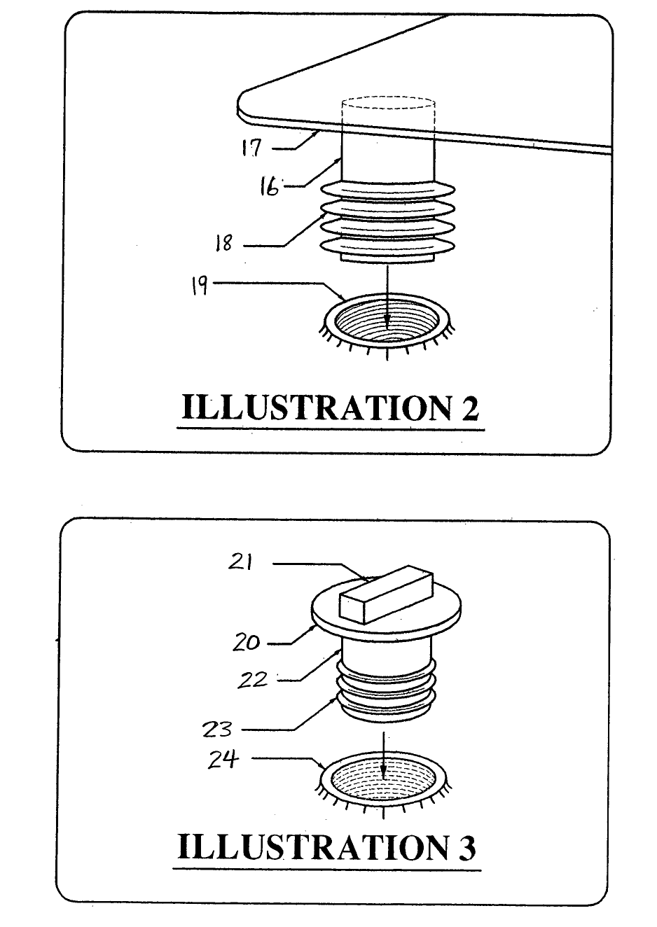

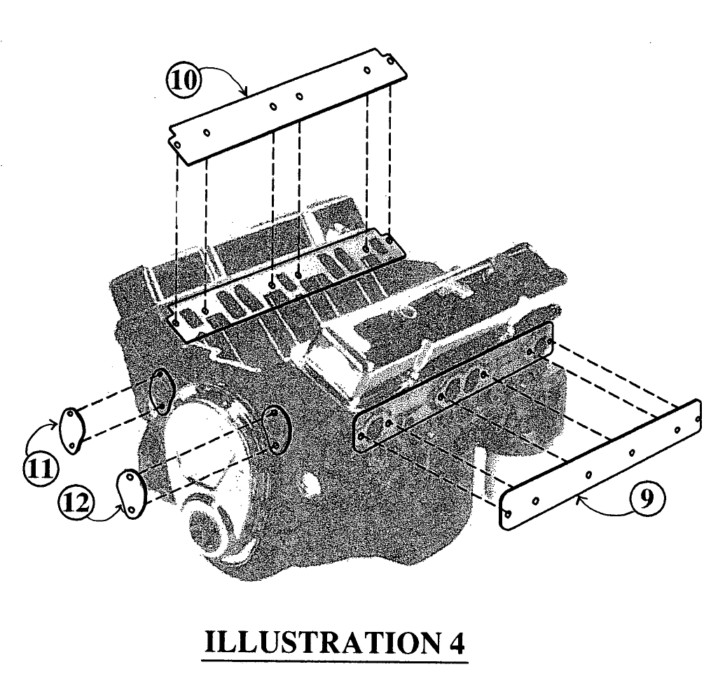

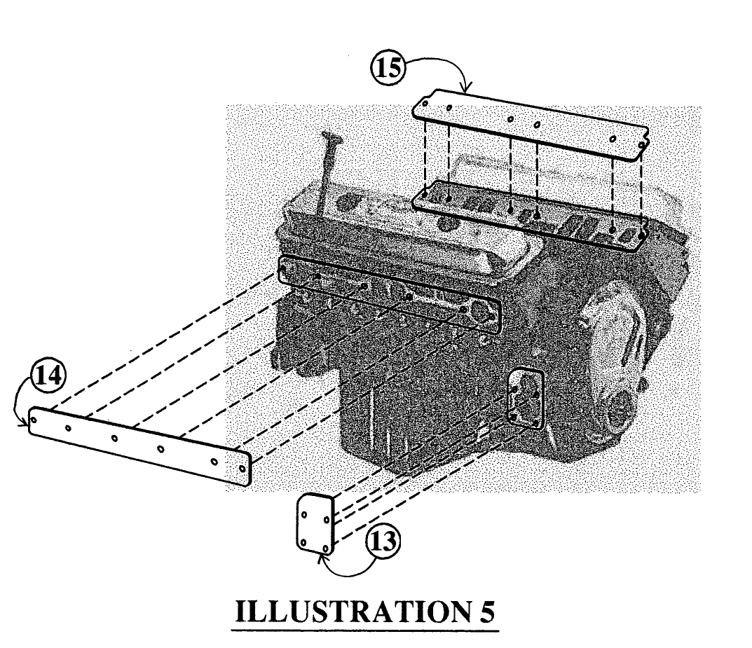

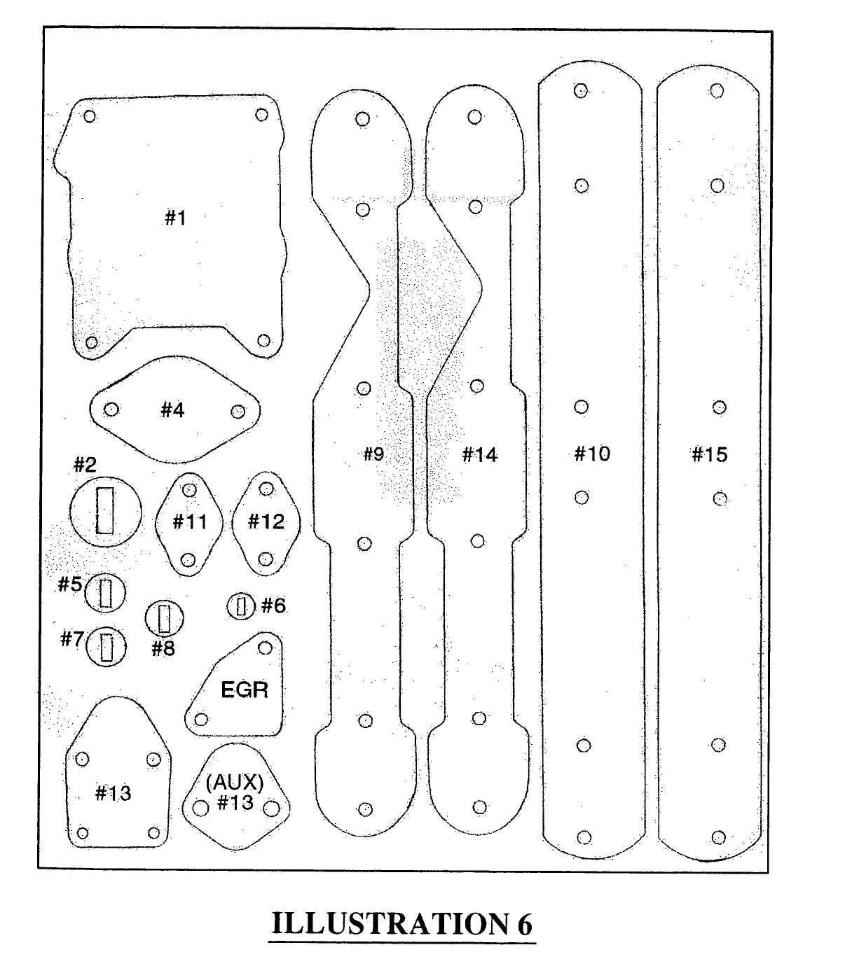

### CROSS-REFERRENCE TO RELATED APPLICATIONS

This application claims priority under 35 U.S.C. sctn. 119(e) to U.S. Patent Provisional Application No. 60/571,787, filed on May 17, 2004, Title, Critical Engine Component Protection Covers, the disclosure of which is expressly incorporated by referrence herein in its entirety.

### BACKGROUND OF INVENTION

When various levels of repair, maintenance, and rebuild (herein referred to as procedures), are performed on gasoline and/or diesel internal combustion engines and certain engine components are involved; such as fuel delivery components (i.e. carburetor, throttle body or port fuel injection systems), ignition distributor, air/fuel intake manifold, exhaust manifold and/or manifolds, engine thermostat and housing, coolant temperature sensor, coolant/water pump, positive crankshaft ventilation (PCV) valve, mechanical fuel pump, exhaust gas recirculation (EGR) valve; their removal from an engine assembly reveal openings or access areas/points (Critical Areas), that lead to other critical operational components within an engine. The problem arises when mechanics are working on or around said critical component openings, foreign objects such as small bolts, screws, washers, clamps, very small hand tools, and debris built-up on or around the engine can inadvertently enter said openings and even unknowingly left there. This situation can create a major problem which would require many hours of unnecessary work to remove said objects or extensive engine disassembly could be required. If said objects were unknowingly left in said openings, situation can adversely alter the operation of component and/or components or cause severe damage to the engine during operation.

When trying to prevent foreign object from said openings mechanics have always stuffed shop raggs or paper towel in said openings to try and prevent object entry. The patent applied in this application deals directly with solving this problem and offers a unique and usable solution.

### STATEMENT REGARDING FEDERALLY SPONSORED RESEARCH OR DEVELOPMENT

None.

### SUMMARY OF RELATED ART

I have found only one, Wade Zimmerman, inventor, Santa Paula, Calif., claiming patent pending on similiar design but very different in method of attachment. Zimmerman's engine covers must be attached to engine utilizing engine components existing hardware utilized for attaching the engine component itself. The method of attaching Zimmerman's covers has several disadvantages by having to install each cover individually, each attachment point utilizes a bolt and/or nut having to be threaded back into a component opening's drilled and tapped holes which is time consuming effort and does not lend itself for everyday use by automotive mechanics. Zimmerman has several design patents issued however I have found no utility patents issued and/or applied for.

### SUMMARY OF INVENTION

Method by which to cover and protect critical engine component openings/access areas and surfaces which are revealed or made accessable by removal of certain engine component and/or components, preventing unwanted and/or inadvertent entry of foreign objects/debris when performing maintenance or repair or rebuild procedures involving any gasoline and/or diesel internal combustion engine.

### DESCRIPTION OF PICTURES AND ILLUSTRATIONS

Picture 1, on page 8, is an eight cylinder gasoline internal combustion engine which I have chosen for illustration purposes, (engine type could be any gasoline and/or diesel single or multi-cylinder-internal combustion engine for illustration), shows engine with components; carburetor (1), ignition distributor (2), coolant/water pump (3), opening for thermostat and; housing (4), coolant temperature sensor opening (5), positive crankshaft ventilation (PCV) valve (6), vacuum supply port opening (7), heater coolant return port opening (8), and exhaust outlet ports for right side cylinder head (9); either mounted in their proper place or removed showing component opening/access areas/points.

Picture 2, on page 9, shows the engine, in Picture 1 page 8, with engine components removed from the intake manifold, (1) showing carburetor removed revealing intake plenum opening, (2) ignition distributor removed revealing the distributor shaft opening, (4) thermostat housing removed revealing the opening to water/coolant flow chamber of the intake manifold, (5) coolant temperature sensor removed revealing another opening to the water/coolant flow chambers of the intake manifold, (8) heater coolant return pipe removed revealing yet another opening to the coolant/water chamber of the intake manifold, and (7) vacuum supply valve opening revealing access point to air intake manifold chambers leading to intake valves in the cylinder heads.

Picture 3, page 10, shows a overhead view of the intake manifold removed from the engine of picture 2 page 9, giving a direct view of the openings revealed when said major engine components are removed for said procedures. The following explanation describes resulting possible effects of said foreign objects/debris inadvertently or unknowingly left in said numbered openings.
(1) intake plenum—foreign objects/debris in this opening would be sucked or drawn down immediately toward or into the intake valves upon engine startup causing restriction of air flow to the combustion chambers of cylinder heads or worse, if lodged between an intake valve, could result in bending or warping the valve immediately and even causing piston damage.
(2) ignition distributor shaft—this opening leads directly to distributor drive gear of the camshaft which directly drives the gear at base of distributor shaft. Objects left in this area would immediately foul the gears and adversely alter engine operations.
(4) thermostat housing said objects left in this area could restrict flow of coolant and even block flow causing engine to overheat.
(5) coolant temperature sensor—would have a greater coolant flow rate restriction due to much smaller size of sensor opening yielding greater restriction.
(7) vacuum supply port—supplies vacuum for power brake system, assist in EGR valve operation, and supplies vacuum for engine emissions system, therefore objects left in this port would adversely alter vacuum supply for all said systems.
(8) heater coolant return port—would also restrict coolant flow in the same manner as (5) due to a smaller opening size of port causing sevier restriction and resulting in engine overheating.

Illustration 1, on page 10, simply shows Picture 3 faded slightly to show more detail of numbered openings with Critical Engine Component Protection Covers in place and performing their function as stated in claims starting on page 5. Covers are depicted in outline form to show greater detail of critical opening coverage and attachment stud alignment.

Illustration 2, on page 11, shows the design of an attachment stud on the reverse side of a Critical Cover. Attachment stud 16 protrudes downward perpendicularly from the reverse side of cover 17 with flexible rings (not limited to this design only) molded at base of stud. Rings 18 slightly flex as they are pressed downward into the threaded bolt hole 19, holding the Cover 17 securely in place while in use, as shown by Covers 1 and 4, Illustration 1, page 10, said multiple attachment studs are securing said covers on their opening/access areas.

Illustration 3, on page 11, is the basic design of Critical Covers, allowing for variances in in opening diameters, for; ignition distributor 2, coolant temperature sensor 5, vacuum supply port 7, and heater coolant return port 8, as they are utilized on said locations where multiple attachment studs are not required. The smaller type covers 20 have tabs 21 designed on top of cover for ease of placement into and removing from type opening 24. All covers fully protect opening areas while the single attachment stud 22 which is perpendicular to the cover 20 on the reverse side has flexible rings 23 (not limited to this design only) that will hold covers securely in place on said type opening.

Illustration 4, on page 12, shows engine, in Pictured 2 page 9, with the air/fuel intake manifold removed revealing the cylinder head Intake ports of the left side of engine. Cylinder head intake valve ports cover 10 is attached down onto head assembly by the attachments studs on the reverse side of covers which are correctly aligned with the existing threaded bolt holes in the head assembly holding the cover in place. Right side of engine shows cylinder head exhaust outlet ports and Cover 9 illustrates it's alignment with the existing bolt holes which allow Cover 9 to be held in place by the attachment studs on the reverse side of cover 9. Covers 11 and 12 are aligned with the inlet and outlet ports revealed by the removal of the coolant/water pump assembly from the front of engine and held in place by the attachment studs on reverse side of covers 11 and 12.

Illustration 5, on page 13, shows mechanical fuel pump drive opening on left side and Critical Cover (13) aligned properly to cover said opening and held in place by attachment studs. Also the left side cylinder head exhaust ports are shown with Critical Cover (14) in alignment and held in place by said attachment studs. The right side is showing intake valve ports on the right side cylinder head with Critical Cover (15) aligned and in place covering the critical intake valve openings and held in place with said attachment studs.

Illustration 6, on page 14, shows Critical Engine Component Protection Covers as they would appear except for the 50% reduction in size for application purposes, when manufactured as a set for this particular type engine for all said component opening/access areas/points.

Pictures 1 and 2, pages 8 and 9, utilize all Critical Engine Component Protection Covers illustrated on Page 16 except for a possible variation in the intake manifold designs which may or may not need the listed EGR labeled cover. Also the fuel pump cover listed as (Aux) for auxiliary is illustrated for use but not required on this particular engine design.

1. cover engine component openings that are revealed when engine components (i.e. carburetor, ignition distributor, water pump, thermostat housing, coolant temperature sensor, positive crankshaft ventiliation valve, intake vacuum supply port, heater coolant return port, exhaust outlet ports of cylinder heads, and intake ports of cylinder heads) are removed during engine maintenance, rebuild, and/or storage procedures and
covering said engine components will prevent metal objects (i.e. lockwashers, nuts, bolts, screws, retainer clips, hose clamps, very small hand tools) from accidental and/or inadvertant entry into said component openings preventing possible engine damage upon engine startup and
covering said engine components will prevent debris (i.e. dirt, old gasket material, carbon particles, foreign material that can be found on engines during maintenance procedures) from accidental and/or inadvertant entry into said component openings preventing possible engine damage upon engine startup and
covering said engine components will prevent nesting insects and animals (i.e. wasps, hornets, mice, rats, chipmonks, squirels) from forming nests and food storage areas within said engine component openings during long term engine maintenance, rebuild, and/or storage procedures and
covering said engine components will prevent damage to machined engine component opening surfaces (i.e. carburetor intake manifold plenum, thermostat housing opening, exhaust port openings, cylinder head air intake ports, water pump supply ports) from accidental and/or inadvertant hand tools being dropped onto said machined metal surfaces causing additional expensive rapairs from impact damage and
covers design, manufactured in various colors, can identify engine manufacturer and/or engine type when utilized as storage covers for a engine rebuilding procedure and/or warehousing operation.

2. be designed to have multiple attachment tabs, molded on covers or attached through said covers perpendicularly from the rear surface of the multiple tab covers as hold down tabs, enabling said tabs to be pressed down into drilled and tapped bolt holes in the machined engine component opening surfaces securely holding multiple tab covers on said components and
be designed to have one large attachment tab, molded and/or attached perpendicularly from rear of single tab engine covers enabling these said covers to be pressed down into the larger engine component openings securely holding the single tab covers in the larger component openings and
due to said attachment tab designs engine component protection covers can be installed quickly by aligning said cover over particular engine component area and pressed into place on the critical area for protection and
due to said attachment tab designs engine component protection covers can be removed quickly by pulling up on edge of said multiple tab covers thereby allowing for repeat utilization throughout an automotive mechanic daily operations.
